(19) United States
(12) Patent Application Publication
(10) Pub. No.: US 2026/0065065 A1
(43) Pub. Date: Mar. 5, 2026

(54) Securing Generative Model Output Using Guardrail-Augmented Prompts And Related System And Methods

(71) Applicant: Oracle International Corporation, Redwood Shores, CA (US)

(72) Inventor: Olaitan Philip Olaleye, Short Hills, NJ (US)

(73) Assignee: Oracle International Corporation, Redwood Shores, CA (US)

(21) Appl. No.: 18/825,296

(22) Filed: Sep. 5, 2024

(51) Int. Cl. G06N 3/091; G06N 3/0475

(52) U.S. Cl. CPC G06N 3/091; G06N 3/0475

(57) ABSTRACT

Techniques for generating augmented prompts are disclosed herein. Augmented prompts and/or guardrails for augmenting prompts are identified and/or generated. Augmented prompts intended to secure output generated by a generative model resulting from the augmented prompts are scored for efficacy. A risk classifier and a rules-based dictionary for augmenting prompts according to a risk class of an initial prompt are used to generate training data. The training data is used to train and/or fine-tune an error-to-prompt model. Augmented prompts and/or efficacy scores for the augmented prompts are used for feedback-based optimization of the error-to-prompt model. The error-to-prompt model selects and/or generates prompt augmentations, such as guardrail phrases, edits, deletions, or the like that secure output generated by the augmented prompt.

### TECHNICAL FIELD

The present disclosure relates to techniques for generating guardrail-augmented prompts to secure output of a generative model.

### BACKGROUND

Generative models are used in many applications to generate output, such as natural language, computer code, or images, based on input prompts. Sometimes, content that produced by generative models is unsafe or incorrect. For example, sensitive data may be unintentionally leaked by models deployed in a commercial setting. Content generated by models may be inappropriate or harmful to users. Unguarded prompts can cause harm in a variety of ways. Thus, there is significant risk to enterprises deploying generative models to generate output based on user input in a public setting.

Techniques in this disclosure may address any of the aforementioned flaws, challenges, and difficulties by providing techniques that result in improved security for model output. The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates an example guardrail-augmented prompt generation system in accordance with one or more embodiments;

FIG. 2A illustrates an example set of operations for generating a secured output using a guardrail-augmented prompt in accordance with one or more embodiments;

FIG. 2B illustrates an example set of operations for training an error-to-prompt model and generating secured output based on a secured prompt generated by the error-to-prompt model in accordance with one or more embodiments;

FIG. 3A illustrates determining an unsafe class for an initial prompt based on an output of a generative model generated using the initial prompt in accordance with one or more embodiments;

FIG. 3B illustrates generating a guarded output using an error-to-prompt dictionary in accordance with one or more embodiments;

FIG. 3C illustrates determining an efficacy score for a prompt in accordance with one or more embodiments;

FIG. 3D illustrates training an error-to-prompt model in accordance with one or more embodiments;

FIG. 3E illustrates optimizing an error-to-prompt model in accordance with one or more embodiments;

FIG. 3F illustrates displaying a secured output generated based on a secured prompt in accordance with one or more embodiments; and

FIG. 4 shows a block diagram that illustrates a computer system in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. GENERAL OVERVIEW
2. GUARDRAIL-AUGMENTED PROMPT GENERATION SYSTEM
3. OPERATIONS FOR GENERATING A SECURED OUTPUT USING A GUARDRAIL-AUGMENTED PROMPT
4. SECURED OUTPUT GENERATION USING A GUARDRAIL-AUGMENTED PROMPT
5. COMPUTER NETWORKS AND CLOUD NETWORKS
6. MICROSERVICE APPLICATIONS
7. HARDWARE OVERVIEW
8. MISCELLANEOUS; EXTENSIONS

### 1. GENERAL OVERVIEW

One or more embodiments provide a technique for securing the output of a model such as a large language model. For a particular prompt, an augmented prompt is generated that secures the output from being unsafe, unwanted, or invalid output. Augmentations for prompts are determined using a rules-based or other system by which guardrail language is added to input prompts to result in augmented, or guarded, prompts. The efficacies of the guardrails for the guarded prompts are scored to generate feedback. The guardrail language and the feedback are used as training data to train an error-to-prompt model to generate guardrail language and/or guardrail-augmented prompts using machine learning to generate the guardrail language. Input prompts are then augmented using the machine learning-generated guardrail language to generate a secured prompt. The secured prompt results in a secured output when provided to a model, such as large language model or code generation model.

Applicant notes that this Overview is non-limiting in nature, and that additional embodiments and related combinations of features are described in this Specification and/or recited in the claims.

### 2. GUARDRAIL-AUGMENTED PROMPT GENERATION SYSTEM

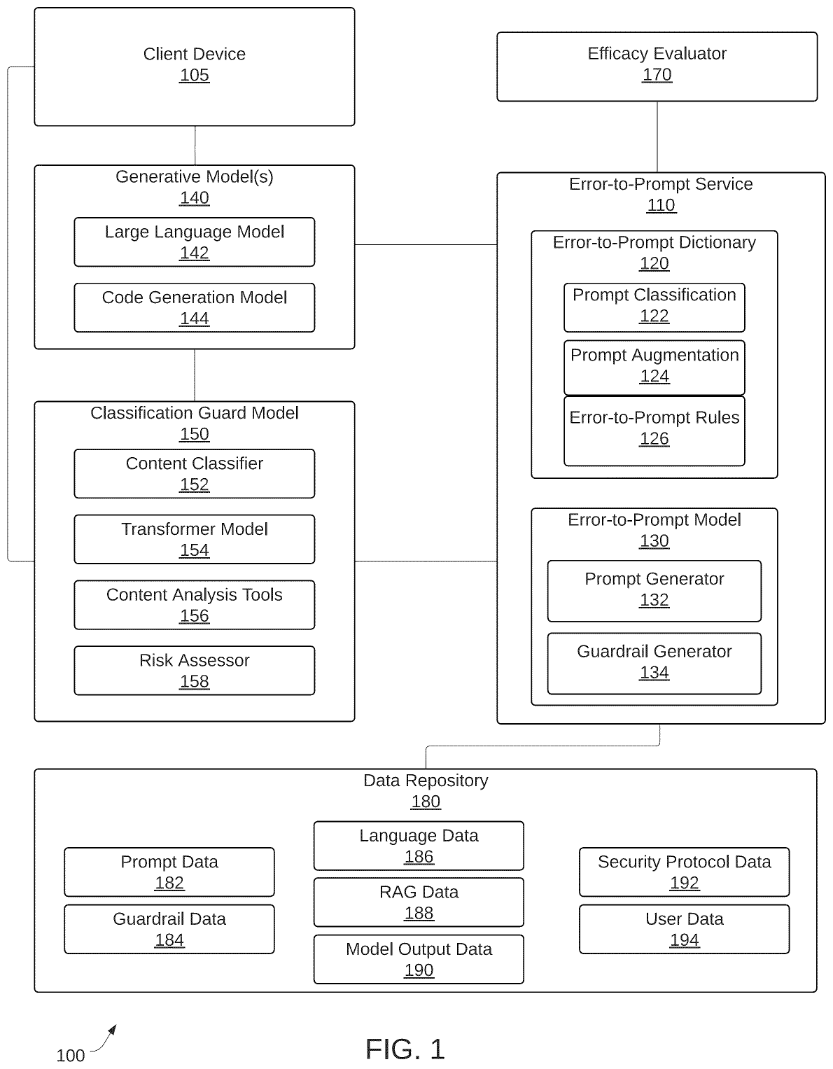

One or more embodiments include a guardrail-augmented prompt generation system such as system 100 illustrated in FIG. 1. System 100 facilitates generation of secured output using a generative model.

In FIG. 1, the system 100 includes a client device 105, an error to prompt service 110, one or more generative models 140, a classification guard model 150 an efficacy evaluator 170, and a data repository 180. In the example, the client device 105 is used to access one or more generative models 140. Example client devices include computers, smart phones, or other computing devices.

The error to prompt service 110 includes an error to prompt dictionary 120 an error-to-prompt model 130. The error to prompt service 110 uses the error to prompt dictionary 120 and/or the error to prompt model 130 to determine a secured prompt from an input prompt and/or an input prompt class. For example, an unsafe prompt resulting in harmful output from a language model is classified unsafe as potentially harmful by a classifier model. The prompt and the potentially harmful classification are provided to error to prompt service 110 and the error-to-prompt dictionary 120 and/or the error-to-prompt model 130 are used to generate a secured prompt that secures the initial prompt from being unsafe or potentially harmful.

The error-to-prompt dictionary 120 includes a set of prompt classifications 122, a set of prompt augmentations 124, and a set of error-to-prompt rules 126. An initial prompt having an unsafe classification 126 is augmented according to a prompt augmentation 124 responsive an error-to-prompt rule 126 for the unsafe classification 122.

Various types of prompt augmentations 124 are used for different content classifications 122 according to the error-to-prompt rules 126. Augmentations include text phrases or other input provided in addition to or instead of an input prompt, including additions, edits, or deletions to an initial prompt. Example guardrails include ethical guardrails that include language prohibiting the LLM from the generating content that could be offensive, discriminatory, or harmful. Content guardrails likewise ensure material produced by the model is suitable for the correct audience and can include a list or filter of topics which should be excluded from an LLM response. Other guardrails can include language for bias mitigation, accuracy, or truthfulness. For code generation models, example augmenting phrases include language prohibiting the model from generating code that will attempt to copy sensitive or copyrighted data or access certain computing resources. Other examples for code generation model guardrail phrases include language to prevent the code generation model from outputting code that can create memory leak or high resource consumption at execution.

Generally, prompt augmentations are used to increase safety in several ways. Some augmentations provide contextual framing to increase accuracy, such as by rephrasing a prompt to request information based on scientific consensus. Some augmentations involve safety enhancements by incorporating disclaimers, warnings, or instructions into prompts to direct the model away from generating potentially harmful content. Some augmented prompts are generated that reduce bias by explicitly requesting a balanced view or by adding information broadening the input from a limited perspective.

The error-to-prompt rules 126 are scored for accuracy, correctness, or efficacy. In some embodiments, a highest scoring rule for a prompt is selected and applied. Furthermore, the rules 126 and the scores for prompts generated by the rules 126 are provided as training data to the error-to-prompt model 130. The error-to-prompt model 130 generates guardrail language based on learned patterns from the rules 126 and the scores.

In the example, the error-to-prompt model 130 includes a prompt generator 132 and a guardrail generator 134. The prompt generator 132 generates secured, augmented prompts based on an initial prompt and an unsafe classification for the prompt. The guardrail generator 134 generates an augmentation or guardrail which, when applied to an initial prompt, results in a secured, augmented prompt. In either case, the secured, augmented, prompt results in a secured output when provided to a LLM or code generation model.

In embodiments, the generative models 140 include a large language model 142 and/or a code generation model 144. Examples include LLaMa, ChatGPT, and/or other large language models 144 for generating natural language output. The code generation model 144 includes a model for generating computer code, machine-language code, and/or the like. In some embodiments, the generative models 140 include text-to-image or text-to-video models.

In FIG. 1, the classification guard model 150 determines a classification for content input into the guard model 150. For example, the classification guard model 150 identifies a type of content as either safe or unsafe. If the content is unsafe, the classification guard model 150 determines a class of the unsafe content. Example classes of unsafe content include content that leaks sensitive data, harmful content, or inaccurate content.

The classification guard model includes a content classifier 152 that is responsible for categorizing incoming data based on various criteria. For instance, the content classifies differentiates between safe content, and different types of unsafe content by analyzing text, and/or metadata associated data.

The classification guard model includes a transformer model 154 that leverages deep learning techniques to process and understand complex data patterns to determine a class for content. For example, a Bidirectional Encoder Representations from Transformers (BERT) model determines if content contains inaccurate content or harmful or malicious instructions.

The classification guard model includes a content analysis tool 156 that examines the content for various attributes. Various content analysis tools 156 are used to determine topics, tone, and/or other attributes of the content by evaluating the language and context used in the content. Content having different attributes is provided with values or flags for the attributes so that the content can be analyzed, such as to improve detection of unsafe content or to cluster like content.

The classification guard model includes a risk assessor 158 that evaluates potential risks associated with the content. An example is assessing model output for signs of irregularities, harmful content, or for the presence of sensitive data. The risk assessor 158 includes rules for evaluating a measure of risk of a content item and/or for evaluating a measure of risk that content resulting from a particular prompt will be unsafe.

The efficacy evaluator 170 includes rules and/or scoring mechanisms for determining an efficacy score for a guardrail or augmentation for a prompt. The efficacy evaluator 170 determines an efficacy score for an augmentation for generating an augmented prompt from an initial prompt. The efficacy evaluator 170 analyzes and/or compares risk values for an initial prompt and for the augmented prompt that has been generated by processing the initial prompt by applying the augmentation.

Generally, the data repository 180 stores data loaded onto the data repository 180 from the error to prompt service 110 and/or another source. In various embodiments, the data repository stores one or more types of data including, but not limited to, prompt data 182, guardrail data 184, language data 186, retrieval augmented generation (RAG) data 188, model output data 190, security protocol data 192, and/or user data 194.

Prompt data 182, includes prompt histories, user prompt histories for a particular user, synthetically generated prompt data, and/or the like. Prompt data 182 includes data generated by the system and/or data imported from another source. Prompt data 182 includes initial prompts and/or augmented versions of initial prompts.

Guardrail data 184, includes guardrail data used for defining various rules-based guardrails as well as guardrail data for generative guardrail language. For example, a particular guardrail includes a rule appending a text phrase to a prompt responsive to detecting that the prompt belongs to a particular unsafe class. Guardrail data 184 includes data input by a user, data generated by the generative guardrail model, synthetic guardrail data generated algorithmically, and the like.

Language data 186 refers to data defining linguistic patterns, vocabularies, syntactic or semantic rules, and/or language model parameters. Language data 186 is generated by the system and/or externally sourced.

Retrieval augmented generation (RAG) data 188 comprises data related to the retrieval mechanisms that support the generation of responses. This data includes indexing information, retrieved documents, context-relevant data, and metadata used to enhance the relevance and accuracy of generated content. RAG data 188 helps bridge the gap between static model knowledge and recent, real-time, or contextual information by enabling the system to pull in pertinent data from various sources during response generation.

Model output data 190 contains data generated by the AI models after processing prompts. This includes the raw outputs of the models, as well as post-processed outputs that have undergone additional layers of refinement or modification based on guardrails, security protocols, or other filters. Model output data 190 can also include logs of previous outputs, which may be used for auditing, quality control, and further model training.

Security protocol data 192 includes data and rules governing the security measures implemented within the system. This data ensures that prompts, user interactions, and outputs comply with established security guidelines, protecting sensitive information from unauthorized access or misuse. Security protocol data 192 includes hashes, encryption keys, access control logs, authentication data, and other information. In cases where security protocol dictates what users are authorized to access content, the security protocol data 192 is used to determine content is unsafe.

User data 194 includes information about users and/or clients of the system, such as user profiles, preferences, interaction histories, and any other data personalized to individual users and/or client devices. User data 194 may be anonymized and/or aggregated to enhance privacy while still enabling the system to provide personalized services to users.

In one or more embodiments, a machine learning algorithm is an algorithm that can be iterated to train a target model f that best maps a set of input variables to an output variable. In particular, a machine learning algorithm is configured to generate and/or train an error-to-prompt model 130.

A machine learning algorithm is an algorithm that can be iterated to train a target model f that best maps a set of input variables to an output variable, using a set of training data. The training data includes datasets and associated labels. The datasets are associated with input variables for the target model f. The associated labels are associated with the output variable of the target model f. The training data may be updated based on, for example, feedback on the predictions by the target model f and accuracy of the current target model f. Updated training data is fed back into the machine learning algorithm, which in turn updates the target model f.

A machine learning algorithm generates a target model f such that the target model f best fits the datasets of training data to the labels of the training data. Additionally, or alternatively, a machine learning algorithm generates a target model/such that when the target model fis applied to the datasets of the training data, a maximum number of results determined by the target model f matches the labels of the training data. Different target models be generated based on different machine learning algorithms and/or different sets of training data. Error-to-prompt models 130 are trained using training data including prompts and efficacy scores as feedback for the prompts.

A machine learning algorithm may include supervised components and/or unsupervised components. Various types of algorithms may be used, such as linear regression, logistic regression, linear discriminant analysis, classification and regression trees, naïve Bayes, k-nearest neighbors, learning vector quantization, support vector machine, bagging and random forest, boosting, backpropagation, and/or clustering.

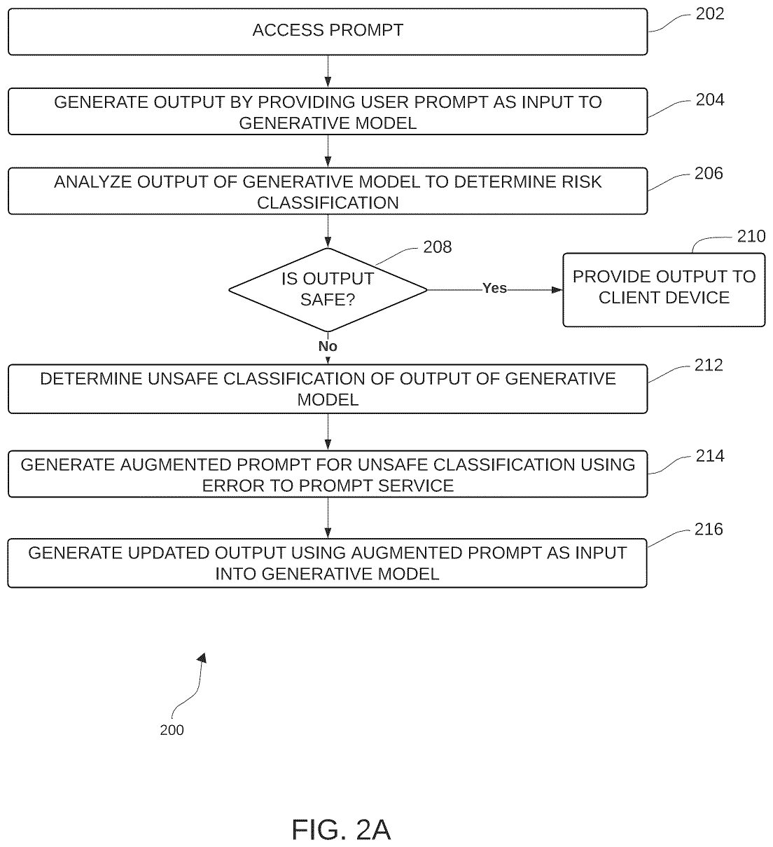

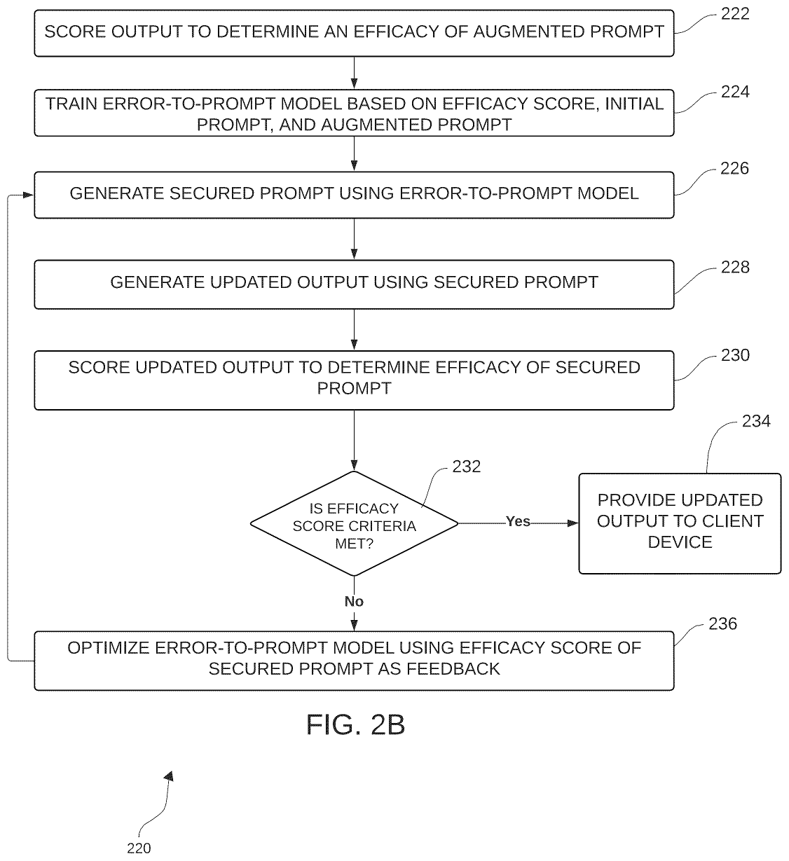

Examples of operations that may be performed by the system 100 are described below with reference to FIGS. 2A-B. As shown, the system 100 is implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a client device.

In one or more embodiments, an interface refers to hardware and/or software configured to facilitate communication between a user and a system. In FIG. 1, one or more interfaces are used to facilitate communication between the system 100 and/or one or more computing devices. Such an interface renders user interface elements and receives input via user interface elements. Examples of interfaces include a GUI, a command line interface, a haptic interface, and a voice command interface. Examples of user interface elements include checkboxes, radio buttons, dropdown lists, list boxes, buttons, toggles, text fields, date and time selectors, command lines, sliders, pages, and forms.

In various embodiments, different components of such an interface are specified in different languages. The behavior of user interface elements is specified in a dynamic programming language such as JavaScript. The content of user interface elements is specified in a markup language, such as hypertext markup language, extensible markup language, user interface language, or another markup language. The layout of user interface elements is specified in a style sheet language such as cascading style sheets. In embodiments, interfaces are specified in one or more other languages, such as Java, C, C++, or another programming language.

### 3. OPERATIONS FOR GENERATING A SECURED OUTPUT USING A GUARDRAIL-AUGMENTED PROMPT

FIGS. 2A-B illustrate example operations for a method of generating a secured output using a guardrail-augmented prompt. FIG. 2A illustrates a method 200 for generating an augmented prompt for an initial prompt and generating output using the augmented prompt.

In the example, the system accesses a prompt (Operation 202). For example, a user of a client device uses the client device to access a large language model. The LLM or other model receives an initial user prompt from the client device via input from the user.

The system generates an output by providing the user prompt as input to a generative model (Operation 204). In various embodiments, the generative model is a large language model, a code generation model, a text-to-image model, or another type of generative model. The system provides the user prompt to the model to generate various types of content. Various suitable generative models are hosted on the internet as public web-based applications. Examples of such models include GPT-4, a language model developed by OpenAI that generates human-like text based on prompts; DALL-E, another OpenAI model designed to create images from textual descriptions; Text-To-Text Transfer Transformer (T5), Bidirectional Encoder Representations from Transformers (BERT) models, etc.

The system analyzes the output of the generative model to determine a risk classification for the output of the generative model (Operation 206). The system analyzes the output of the generative model to determine a risk classification by evaluating the content of the output against criteria that assess potential risks such as harm, misinformation, bias, or ethical concerns. The analysis involves natural language processing and/or computer code processing techniques to identify sensitive topics, inappropriate language, malicious instructions, and/or the like. The system categorizes the content into different risk classes based on the type of risk and/or different risk levels based on the severity of the risk.

The system determines if the output of the generative model is safe (Operation 208). In some embodiments, if the system determines the output is safe, the output is provided to a client device (Operation 210). For example, the output is loaded onto a client device and displayed on a monitor or screen of the client device. In some embodiments, the system determines if the initial prompt is safe. In such embodiments where an initial prompt is determined to be unsafe prior to generating output using the initial prompt, the generating the output using the initial prompt is optional.

If the system determines the output is not safe, the system determines an unsafe classification of the output of the generative model (Operation 212). Once the output of the generative model has been classified as unsafe, the system further determines a class of unsafe content. For example, for a particular piece of unsafe content, the system determines that the content is unsafe due to computer code within the content causing excess resource consumption or memory leak. In various embodiments, unsafe content is classified as unsafe due to including sensitive data, illegal content, and/or other types of prohibited or harmful content. In some embodiments, the initial prompt is analyzed and/or classified as unsafe without output being generated from the initial prompt. In such embodiments, an unsafe classification for the prompt is determined based on the analysis of the prompt. Generating output using the initial prompt is optional in this case.

The system generates an augmented prompt for the unsafe classification using an error to prompt service (Operation 214). In various embodiments, the error-to-prompt service includes an error-to-prompt dictionary and/or an error-to-prompt model. The error-to-prompt dictionary and/or the error-to-prompt model output an augmentation or augmented prompt based on the unsafe class and the initial prompt. The error-to-prompt dictionary uses a set of rules to determine an augmentation. One example rule maps an unsafe class to an augmenting textual phrase for that class. In another example, a rule provides a template for deleting and/or replacing certain text from a prompt. In this example, the text to be replaced is identified by the template and replacement language, if any, is identified by the template for the text to be replaced. Another example rule includes instructions to append language to a prompt to include instructions or other language prohibiting the output from belonging to the unsafe class.

The system generates an updated output by providing the augmented prompt as input to a generative model (Operation 216). For example, an augmented prompt that has been augmented by an error-to-prompt dictionary rule and/or augmented according to the output of an error-to-prompt model is input into a generative model. The generative model generates a safeguarded output based on the augmented prompt. In various embodiments, the safeguarded output is provided to a client device for viewing by a user. In some embodiments, the safeguarded output, initial prompt, and/or augmented prompt is provided an error-to-prompt model training data collector which provides the safeguarded output as training data to an error-to-prompt model trainer. Also, the augmented prompt and/or safeguarded output are scored for efficacy.

FIG. 2B illustrates a method 220 for training and/or finetuning an error-to-prompt model. In some embodiments, the system generates secured output based on a secured prompt generated by the error-to-prompt model. For example, training is achieved by scoring an augmented prompt and/or an LLM output generated using the prompt to determine an efficacy score of the augmented prompt, and training and/or fine-tuning an error-to-prompt model using the efficacy score.

The system scores the output to determine an efficacy score of the augmented prompt (Operation 222). In some cases, the system scores the augmented prompt to determine an efficacy of the augmented prompt instead of or as well as scoring the output. In embodiments, the system determines an efficacy score using a scoring template. The system scores one or more outputs generated using the augmented prompt according to the scoring template.

The system trains a guardrail generation model based on the efficacy score, the initial prompt, and the augmented prompt (Operation 224). In embodiments, the system also uses LLM outputs generated from the prompt and/or the augmented prompt. If other prompt and feedback data is available, the system ingests the information. For example, the system uses a dictionary of rules used to determine augmentations for particular prompts and/or prompt classes. The system uses the augmentations to generate augmented prompts that are scored and/or ingested as training data by a machine learning model training algorithm.

The system generates a secured prompt using the error-to-prompt model (Operation 226). Prompts input into the error-to-prompt model are augmented according to their class (e.g., safe, unsafe—harmful, unsafe—sensitive data, unsafe—memory leak, etc.) to generate a secured prompt. For example, an input prompt is classified as unsafe due to requesting content that could contain prohibited material. The input prompt and the unsafe classification are provided to the error-to-prompt model, which has been previously trained to output secured prompts responsive to an input prompt and a classification being input into the error-to-prompt model.

In embodiments, the error-to-prompt model includes a generative guardrail model. A generative guardrail model is a language model trained using a dictionary that is restricted to guardrail vocabulary. For example, an error-to-prompt dictionary includes a vocabulary which is used as trained data for a generative guardrail model. The generative guardrail model is able to be trained using a dictionary that is smaller than an LLM vocabulary.

The system generates an updated output using the generative model (Operation 228). For example, an augmented prompt is input into a code generation model to generate an output. In this example, the augmented prompt, which requests generation of an application, is augmented to include the augmenting phrase “without any possibility of memory leak” responsive to an unsafe classification for an initial prompt involving a possible memory leak. The updated output does not have a possible memory leak due at least in part to the augmented prompt resulting from an augmentation of the initial prompt.

The system scores the updated output to determine an efficacy of the secured prompt (Operation 230). To empirically determine an efficacy score for a prompt and/or output, various attributes, such as the accuracy, safety, and/or success are measured. Accuracy is measured by comparing the model's output to benchmark answers or factual sources, using metrics like precision, recall, and F1 score. Safety is assessed by evaluating the output for harmful, inappropriate, or biased content through both human review and automated tools. Empirical measurement involves introducing prompt augmentations likely to provoke unsafe responses and tracking the frequency of such outputs. The use of content moderation APIs or bias detection frameworks provides additional quantitative data to support safety evaluations. Success is gauged by the prompt's success. This can be measured through user feedback, unit testing, satisfaction surveys, engagement metrics, and the like. A total efficacy score is derived by aggregating these individual assessments, providing a comprehensive evaluation of the prompt's performance.

The system determines if an efficacy score criteria is met (Operation 232). Generally, an efficacy score is a measure of how well a model's output meets desired criteria. In one example, the efficacy score includes a total score and individual scores a plurality of scored parameters. An efficacy score criteria is based on the total score, an individual score, and/or a combination of individual scores. For example, a particular efficacy score has a high accuracy score (e.g. above 50 out of 100), a low safety score (e.g. below 50 out of 100), and a medium total score that is an average or sum of the other scores. In some cases, different criteria apply for different types of users depending on the type of user and/or permissions for the user.

If the efficacy score criteria is met, the system provides the updated output to a client device (Operation 234). For example, the updated output is presented on a display of a client device such as a computer.

If the system determines the efficacy score criteria is not met, the system optimizes the error-to-prompt model using the efficacy score of the secured prompt as feedback (Operation 236). In some embodiments, the system also optimizes the error-to-prompt model using the efficacy score of the secured prompt as feedback regardless of whether the efficacy score criteria is met.

Using feedback-based optimization, the outputs of the error-to-prompt model are evaluated according to the efficacy parameters and used to iteratively improve performance of the model. In this approach, the model's outputs are assessed against the efficacy criteria, and the feedback from this assessment is used to change parameters for further training or for adjusting the model.

During fine-tuning, the model is adjusted to maximize these efficacy scores. The process involves modifying the model's weights, parameters, and/or hyperparameters so that, over time, it produces outputs that better align with the desired outcomes. The error-to-prompt model learns from this feedback, improving its efficacy and/or efficiency over time. In embodiments, the iterative process refines the error-to-prompt model's performance until a desired efficacy is reached, thus securing the resulting output.

### 4. SECURED OUTPUT GENERATION USING A GUARDRAIL-AUGMENTED PROMPT

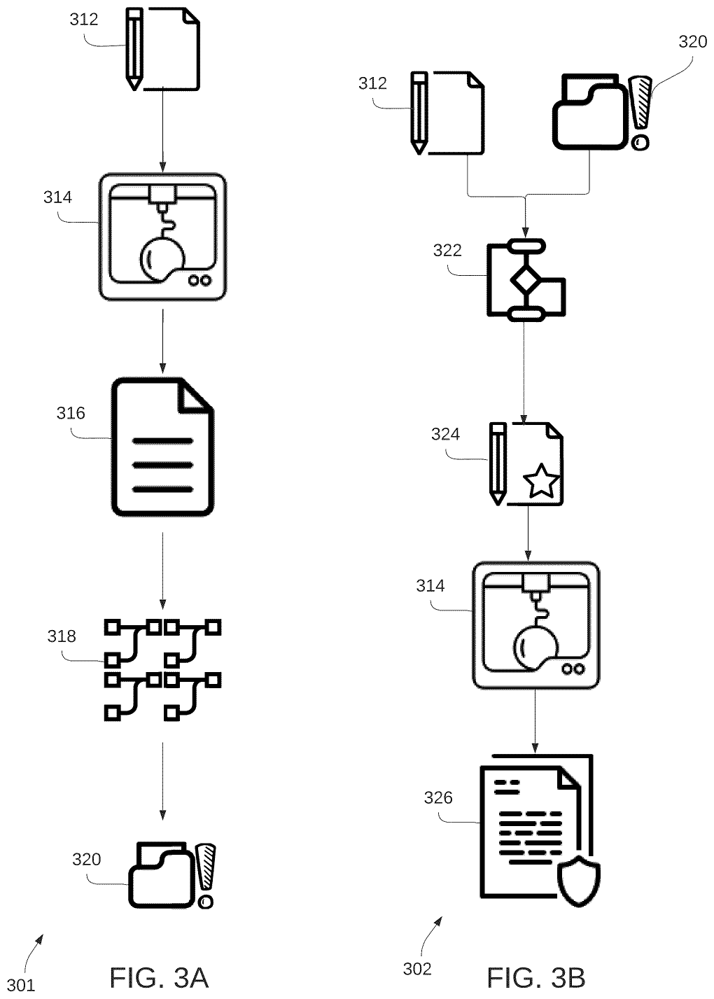

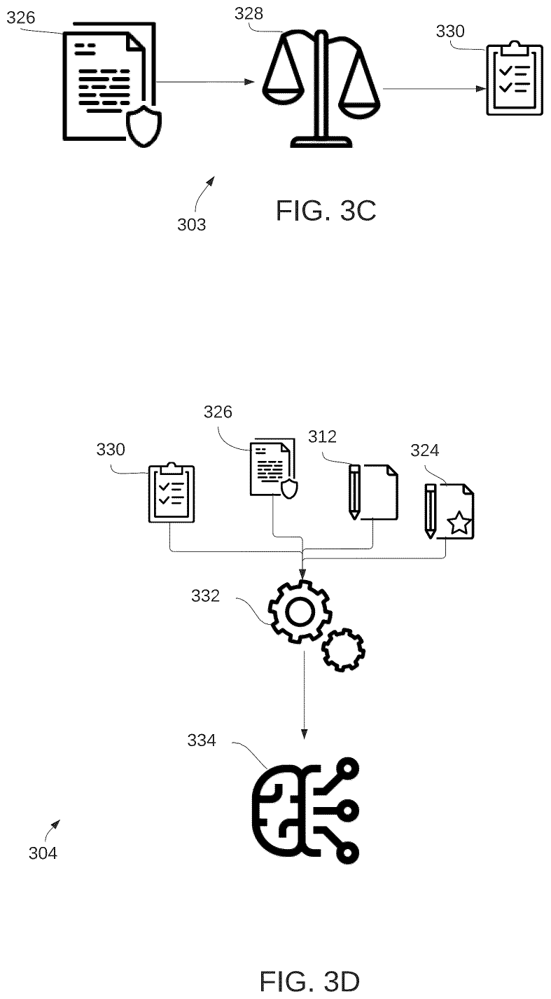

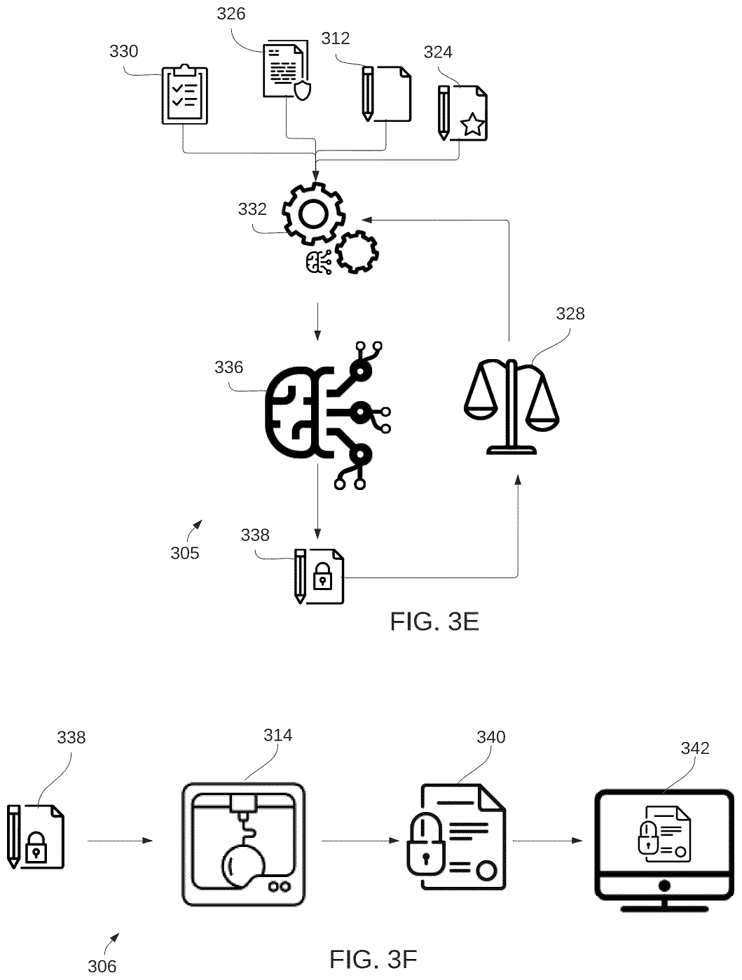

FIGS. 3A-F illustrate an example of generating secured output using a secured, guardrail-augmented prompt.

FIG. 3A illustrates an example 301 of determining an unsafe class for an initial prompt based on an output of a generative model generated using the initial prompt in accordance with one or more embodiments. In FIG. 3A, an initial prompt 312 is input into an LLM 314. Various language models or code generations models are suitable for this purpose.

The LLM 314 generates an initial output 316 based on the initial input 312. The initial output 316 is input into a classification model 318. The classification model determines whether the initial output 316 is safe or unsafe and, if unsafe, determines what class of unsafe content the initial output 316 is. The classification model implements various classification tools and/or threat detection tools to classify prompts and/or outputs.

In the example, the initial output 316 is classified as unsafe and the classification model 318 outputs an unsafe classification 320 corresponding to the unsafe class of the initial output 316. For example, if the initial output 316 includes incorrect information the prompt is classified as unsafe with an unsafe class as incorrect information.

FIG. 3B illustrates an example 302 of generating a guarded output using an error-to-prompt dictionary in accordance with one or more embodiments. In FIG. 3B, an initial prompt 312 and an unsafe classification 320 are input into an error-to-prompt dictionary 322. The error-to-prompt dictionary 322 is a rules dictionary, decision tree, or other static model which provides instructions for augmenting an input prompt based on an unsafe classification. Example instructions include adding, to the prompt, a particular phrase identified by a rule corresponding to the unsafe type; or removing, from the prompt, a particular phrase identified by a rule corresponding to the unsafe type.

The error-to-prompt dictionary 322 outputs an updated prompt 324 which has been augmented based instructions provided by the error-to-prompt dictionary 322. The updated prompt 324 is input into the LLM 314 to generate an updated output 326. The updated output 326 is generated using the output of the error-to-prompt dictionary 322 and is thus guarded from including some unsafe content due to the augmentation provided by the error-to-prompt dictionary 322.

FIG. 3C illustrates an example 303 of determining an efficacy score for a prompt in accordance with one or more embodiments. In FIG. 3C updated output 326 is provided to an efficacy evaluator 328. The efficacy evaluator 328 determines an efficacy score 330 of the updated output 326. In various embodiments, the efficacy evaluator 328 provides efficacy scores to the system for various prompts and/or outputs from models that were generated using the prompts. The efficacy evaluator determines scores for one or more criteria. In some embodiments, the efficacy evaluator generates one or more outputs based on a prompt. The one or more outputs are scored according to a template and/or scoring criteria to determine one or more efficacy scores for the prompt.

FIG. 3D illustrates an example 304 of training an error-to-prompt model for generating guardrail-augmented prompts in accordance with one or more embodiments. In FIG. 3D, efficacy scores 330, initial prompts 312, updated prompts 324, and/or updated outputs 326 are provided as training data to an error-to-prompt model trainer 332. For example, a training data collector collects, parses, and/or preprocesses prompt data, efficacy score data, and/or output data as training to be used for machine learning. The error to prompt model trainer 332 uses the training data to train an error-to-prompt model 334 by analyzing the efficacy scores, prompts, and/or outputs to determine model weights, parameters, and/or hyperparameters for the error-to-prompt model 334.

FIG. 3E illustrates an example 305 of optimizing an error-to-prompt model for generating guardrail-augmented prompts in accordance with one or more embodiments. In FIG. 3E, efficacy scores 330, initial prompts 312, updated prompts 324, and/or updated outputs 326 are provided as training data to an error-to-prompt model trainer 332. The error to prompt model trainer 332 uses the training data to fine tune the error-to-prompt model 334 to result in an optimized model 336. The optimized model 336 is used to generate a secure prompt 338.

In embodiments, an efficacy of the secure prompt 338 is determined by the efficacy evaluator 328. The secured prompt 338 and an efficacy score for the secured prompt 338 are provided as feedback to the error-to-prompt model trainer 332 to optimize the optimized model 336. In embodiments, a feedback process continues until an efficacy score criteria is reached. Example efficacy score criteria include an accuracy or correctness threshold (e.g. 50%, 85%, 99%, or a higher or lower percentage), or another criterion. Through iterative cycles of prompt generation, output evaluation, and model fine-tuning, the error-to-prompt model is trained to produce prompts with increasing efficacy.

FIG. 3F illustrates an example 306 of displaying a secured output generated based on a secured prompt in accordance with one or more embodiments. In FIG. 3F, the secured prompt 338 is provided to the LLM 314. In embodiments, the secured prompt 338 is provided to the LLM 314 responsive to a determination that the secured prompt has met an efficacy criterion.

In the example, the LLM 314 generates a secured output 340 based on the secured prompt 338. The secured output 340 is provided to a client device 342. For example, a computer or smartphone inputting an initial prompt receives a secured output 340 generated using a secured prompt 338, the secured prompt 338 being generated based on the initial prompt and an unsafe class of the initial prompt by an error-to-prompt service as described herein. In embodiments, the secured output 340 is provided to the client device 342 responsive to a determination that the secured output 340 and/or the secured prompt 338 have met an efficacy criterion.

### 5. COMPUTER NETWORKS AND CLOUD NETWORKS

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (“NAT”). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as, a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis.

Network resources assigned to each request and/or client may be scaled up or down based on, for example, (a) the computing services requested by a particular client, (b) the aggregated computing services requested by a particular tenant, and/or (c) the aggregated computing services requested of the computer network. Such a computer network may be referred to as a “cloud network.”

In an embodiment, a service provider provides a guardrail-augmented prompt generation system via a cloud network to one or more end users. Various service models may be implemented by the cloud network, including but not limited to Software-as-a-Service (SaaS), Platform-as-a-Service (PaaS), and Infrastructure-as-a-Service (IaaS). In SaaS, a service provider provides end users the capability to use the service provider's applications, which are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In an embodiment, various deployment versions of a guardrail-augmented prompt generation system may be implemented by a computer network, including but not limited to a private cloud, a public cloud, and a hybrid cloud. In a private cloud, network resources are provisioned for exclusive use by a particular group of one or more entities (the term “entity” as used herein refers to a corporation, organization, person, or other entity). The network resources may be local to and/or remote from the premises of the particular group of entities. In a public cloud, cloud resources are provisioned for multiple entities that are independent from each other (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In an embodiment, tenants of a multi-tenant computer network are independent of each other. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QoS) requirements, tenant isolation, and/or consistency. The same computer network may need to implement different network requirements demanded by different tenants.

In one or more embodiments, in a multi-tenant computer network, tenant isolation is implemented to ensure that the applications and/or data of different tenants are not shared with each other. Various tenant isolation approaches may be used.

In an embodiment, each tenant is associated with a tenant ID. Each network resource of the multi-tenant computer network is tagged with a tenant ID. A tenant is permitted access to a particular network resource only if the tenant and the particular network resources are associated with a same tenant ID.

In an embodiment, each tenant is associated with a tenant ID. Each application, implemented by the computer network, is tagged with a tenant ID. Additionally, or alternatively, each data structure and/or dataset, stored by the computer network, is tagged with a tenant ID. A tenant is permitted access to a particular application, data structure, and/or dataset only if the tenant and the particular application, data structure, and/or dataset are associated with a same tenant ID.

As an example, each database implemented by a multi-tenant computer network may be tagged with a tenant ID. Only a tenant associated with the corresponding tenant ID may access data of a particular database. As another example, each entry in a database implemented by a multi-tenant computer network may be tagged with a tenant ID. Only a tenant associated with the corresponding tenant ID may access data of a particular entry. However, the database may be shared by multiple tenants.

In an embodiment, a subscription list indicates which tenants have authorization to access which applications. For each application, a list of tenant IDs of tenants authorized to access the application is stored. A tenant is permitted access to a particular application only if the tenant ID of the tenant is included in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network may only be transmitted to other devices within the same tenant overlay network. Encapsulation tunnels are used to prohibit any transmissions from a source device on a tenant overlay network to devices in other tenant overlay networks. Specifically, the packets, received from the source device, are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

### 7. MICROSERVICE APPLICATIONS

According to one or more embodiments, the techniques described herein are implemented in a microservice architecture. A microservice in this context refers to software logic designed to be independently deployable, having endpoints that may be logically coupled to other microservices to build a variety of applications, for example, by logically coupling a guardrail-augmented prompt generation system to a software logic endpoint. Applications built using microservices are distinct from monolithic applications, which are designed as a single fixed unit and generally comprise a single logical executable. With microservice applications, different microservices are independently deployable as separate executables. Microservices may communicate using HyperText Transfer Protocol (HTTP) messages and/or according to other communication protocols via API endpoints. Microservices may be managed and updated separately, written in different languages, and be executed independently from other microservices.

Microservices provide flexibility in managing and building applications. Different applications may be built by connecting different sets of microservices without changing the source code of the microservices. Thus, the microservices act as logical building blocks that may be arranged in a variety of ways to build different applications. Microservices may provide monitoring services that notify a microservices manager (such as If-This-Then-That (IFTTT), Zapier, or Oracle Self-Service Automation (OSSA)) when trigger events from a set of trigger events exposed to the microservices manager occur. Microservices exposed for an application may additionally, or alternatively, provide action services that perform an action in the application (controllable and configurable via the microservices manager by passing in values, connecting the actions to other triggers and/or data passed along from other actions in the microservices manager) based on data received from the microservices manager. The microservice triggers and/or actions may be chained together to form recipes of actions that occur in optionally different applications that are otherwise unaware of or have no control or dependency on each other. These managed applications may be authenticated or plugged in to the microservices manager, for example, with user-supplied application credentials to the manager, without requiring reauthentication each time the managed application is used alone or in combination with other applications.

In one or more embodiments, microservices may be connected via a GUI. For example, microservices may be displayed as logical blocks within a window, frame, other element of a GUI. A user may drag and drop microservices into an area of the GUI used to build an application. The user may connect the output of one microservice into the input of another microservice using directed arrows or any other GUI element. The application builder may run verification tests to confirm that the output and inputs are compatible (e.g., by checking the datatypes, size restrictions, etc.)

### Triggers

The techniques described above may be encapsulated into a microservice, according to one or more embodiments. In other words, a microservice may trigger a notification (into the microservices manager for optional use by other plugged in applications, herein referred to as the “target” microservice) based on the above techniques and/or may be represented as a GUI block and connected to one or more other microservices. The trigger condition may include absolute or relative thresholds for values, and/or absolute or relative thresholds for the amount or duration of data to analyze, such that the trigger to the microservices manager occurs whenever a plugged-in microservice application detects that a threshold is crossed. For example, a user may request a trigger into the microservices manager when the microservice application detects a value has crossed a triggering threshold.

In one embodiment, the trigger, when satisfied, might output data for consumption by the target microservice. In another embodiment, the trigger, when satisfied, outputs a binary value indicating the trigger has been satisfied, or outputs the name of the field or other context information for which the trigger condition was satisfied. Additionally or alternatively, the target microservice may be connected to one or more other microservices such that an alert is input to the other microservices. Other microservices may perform responsive actions based on the above techniques, including, but not limited to, deploying additional resources, adjusting system configurations, and/or generating GUIs.

### Actions

In one or more embodiments, a plugged-in microservice application may expose actions to the microservices manager. The exposed actions may receive, as input, data or an identification of a data object or location of data, that causes data to be moved into a data cloud.

In one or more embodiments, the exposed actions may receive, as input, a request to increase or decrease existing alert thresholds. The input might identify existing in-application alert thresholds and whether to increase or decrease, or delete the threshold. Additionally, or alternatively, the input might request the microservice application to create new in-application alert thresholds. The in-application alerts may trigger alerts to the user while logged into the application, or may trigger alerts to the user using default or user-selected alert mechanisms available within the microservice application itself, rather than through other applications plugged into the microservices manager.

In one or more embodiments, the microservice application may generate and provide an output based on input that identifies, locates, or provides historical data, and defines the extent or scope of the requested output. The action, when triggered, causes the microservice application to provide, store, or display the output, for example, as a data model or as aggregate data that describes a data model.

### 8. HARDWARE OVERVIEW

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

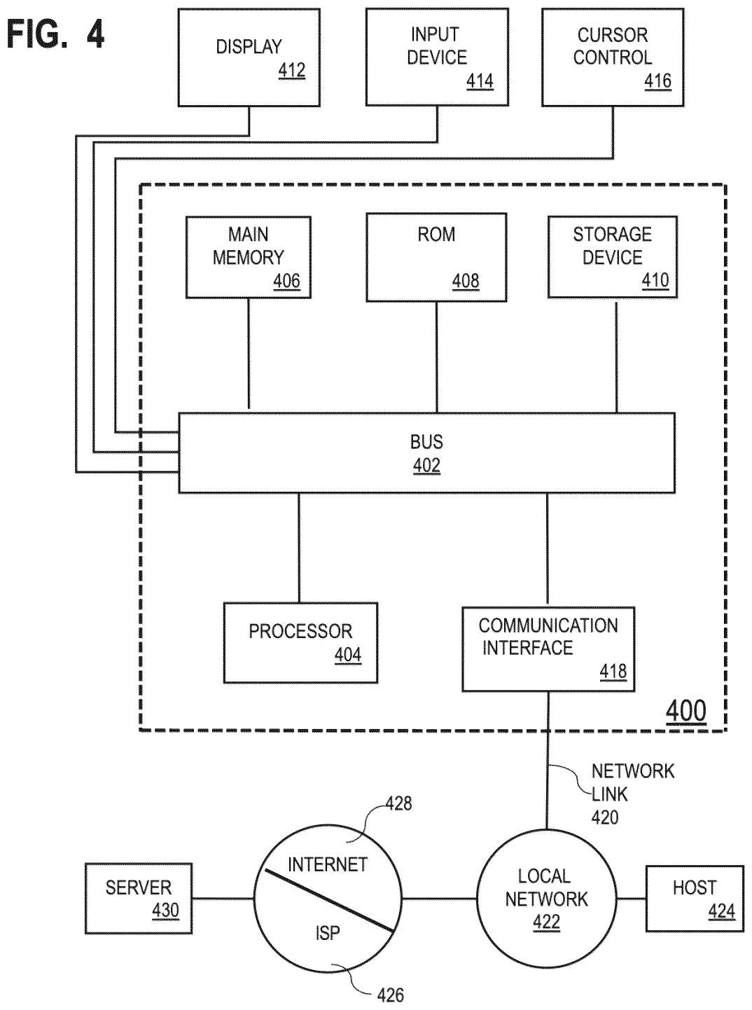

For example, FIG. 4 is a block diagram that illustrates a computer system 400 upon which an embodiment of the disclosure may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk, optical disk, or a Solid State Drive (SSD) is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 410. Volatile media includes dynamic memory, such as main memory 406. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

### 9. MISCELLANEOUS; EXTENSIONS

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions which, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. A method, comprising:
accessing a first prompt;
determining a risk classification for the first prompt;
generating one or more prompts based on the risk classification, the first prompt, and an output of an error to prompt service, the output of the error to prompt service being generated by the error to prompt service based on determining augmenting language for the risk classification;
inputting the one or more prompts into a generative model to produce an output of the generative model; and
storing the output of the generative model, wherein the method is performed by at least one device including a hardware processor.

2. The method of claim 1, comprising:
accessing an initial output of the generative model, the initial output being generated by the generative model in response to the first prompt being input into the generative model; and
analyzing the initial output of the generative model to determine a risk classification for the initial output of the generative model.

3. The method of claim 2, comprising:
determining the risk classification for the first prompt based on the output of a classification model;
responsive to the risk classification being safe, outputting the initial output; and
responsive to the risk classification being not safe:
determining a risk class for the first prompt; and
providing the risk class to the error to prompt model.

4. The method of claim 1, wherein:
the output of the error to prompt service is generated based on a dictionary rule for risk classification, the dictionary rule including a mapping from one or more risk classes to one or more augmenting phrases.

5. The method of claim 1, wherein:
the output of the error to prompt service is based on an output of a guardrail generation model in response to the risk classification, the guardrail generation model having been trained using machine learning to generate and out augmenting phrases for prompts input into the guardrail generation model.

6. The method of claim 5, wherein:
the guardrail generation model is trained using training data comprising (1) outputs of the error to prompt service generated based on dictionary rules and (2) efficacy scores for the outputs of the error to prompt service generated based on dictionary rules.

7. The method of claim 5, comprising:
generating an augmented prompt based on the output of the guardrail generation model;
generating a secured output of the generative model by inputting the augmented prompt into the generative model;
determining an efficacy score for the output of the error to prompt service based on the secured output of the generative model; and
providing the efficacy score as feedback to the guardrail generation model to optimize the guardrail generation model.

8. One or more non-transitory computer readable media comprising instructions which, when executed by one or more hardware processors, cause performance of operations comprising:
accessing a first prompt;
determining a risk classification for the first prompt;
generating a one or more prompts based on the risk classification, the first prompt, and an output of an error to prompt service, the output of the error to prompt service being generated by the error to prompt service based on determining augmenting language for the risk classification;
inputting the one or more prompts into a generative model to produce an output of the generative model; and
storing the output of the generative model.

9. The media of claim 8, the operations comprising:
accessing an initial output of the generative model, the initial output being generated by the generative model in response to the first prompt being input into the generative model; and
analyzing the initial output of the generative model to determine a risk classification for the initial output of the generative model.

10. The media of claim 9, the operations comprising:
determining the risk classification for the first prompt based on the output of a classification model;
responsive to the risk classification being safe, outputting the initial output; and
responsive to the risk classification being not safe:
determining a risk class for the first prompt; and
providing the risk class to the error to prompt model.

11. The media of claim 8, wherein:
the output of the error to prompt service is generated based on a dictionary rule for risk classification, the dictionary rule including a mapping from one or more risk classes to one or more augmenting phrases.

12. The media of claim 8, wherein:
the output of the error to prompt service is based on an output of a guardrail generation model in response to the risk classification, the guardrail generation model having been trained using machine learning to generate and out augmenting phrases for prompts input into the guardrail generation model.

13. The media of claim 12, wherein:
the guardrail generation model is trained using training data comprising (1) outputs of the error to prompt service generated based on dictionary rules and (2) efficacy scores for the outputs of the error to prompt service generated based on dictionary rules.

14. The media of claim 12, the operations comprising:
generating an augmented prompt based on the output of the guardrail generation model;
generating a secured output of the generative model by inputting the augmented prompt into the generative model;
determining an efficacy score for the output of the error to prompt service based on the secured output of the generative model; and
providing the efficacy score as feedback to the guardrail generation model to optimize the guardrail generation model.

15. A system comprising:
at least one device including a hardware processor;
the system being configured to perform operations comprising:
accessing a first prompt;
determining a risk classification for the first prompt;
generating one or more prompts based on the risk classification, the first prompt, and an output of an error to prompt service, the output of the error to prompt service being generated by the error to prompt service based on determining augmenting language for the risk classification;
inputting the one or more prompts into a generative model to produce an output of the generative model; and
storing the output of the generative model.

16. The system of claim 15, the operations comprising:
accessing an initial output of the generative model, the initial output being generated by the generative model in response to the first prompt being input into the generative model; and
analyzing the initial output of the generative model to determine a risk classification for the initial output of the generative model.

17. The system of claim 16, the operations comprising:
determining the risk classification for the first prompt based on the output of a classification model;
responsive to the risk classification being safe, outputting the initial output; and
responsive to the risk classification being not safe:
determining a risk class for the first prompt; and
providing the risk class to the error to prompt model.

18. The system of claim 15, wherein:
the output of the error to prompt service is generated based on a dictionary rule for risk classification, the dictionary rule including a mapping from one or more risk classes to one or more augmenting phrases.

19. The system of claim 15, wherein:
the output of the error to prompt service is based on an output of a guardrail generation model in response to the risk classification, the guardrail generation model having been trained using machine learning to generate and out augmenting phrases for prompts input into the guardrail generation model.

20. The system of claim 19, wherein:
the guardrail generation model is trained using training data comprising (1) outputs of the error to prompt service generated based on dictionary rules and (2) efficacy scores for the outputs of the error to prompt service generated based on dictionary rules; the operations comprising:
generating an augmented prompt based on the output of the guardrail generation model;
generating a secured output of the generative model by inputting the augmented prompt into the generative model;
determining an efficacy score for the output of the error to prompt service based on the secured output of the generative model; and
providing the efficacy score as feedback to the guardrail generation model to optimize the guardrail generation model.
